(19) United States
(12) Patent Application Publication
(10) Pub. No.: US 2019/0329240 A1
(43) Pub. Date: Oct. 31, 2019

(54) Analysis Apparatus

(71) Applicant: Hitachi High-Technologies Corporation, Minato-ku, Tokyo (JP)

(72) Inventors: Hirokazu KATO, Minato-ku, Tokyo (JP); Tatsuya YAMASHITA, Minato-ku, Tokyo (JP); Junji ISHIZUKA, Minato-ku, Tokyo (JP); Tomohiro SHOJI, Minato-ku, Tokyo (JP); Toshinari SAKURAI, Minato-ku, Tokyo (JP)

(21) Appl. No.: 15/998,963

(22) PCT Filed: Feb. 17, 2016
(86) PCT No.: PCT/JP2016/054494

§ 371 Date: Aug. 17, 2018

(51) Int. Cl. B01L 3/00; G01N 35/08; G01N 35/10; B01L 7/00

(52) U.S. Cl. CPC B01L 3/502; G01N 35/08; G01N 35/1002; G01N 35/1095; B01L 7/52; B01L 2200/141; B01L 2200/16; B01L 2300/14; B01L 2400/0475; B01L 2300/1822; B01L 2300/049; B01L 3/567

(57) ABSTRACT

A conventional solution exchanging method in a next-generation sequencer needs a reagent amount four or more times greater than an in-flow cell flow passage volume in order to efficiently promote a chemical reaction by replacing a reagent A in the flow cell with a new reagent B. Thus, the reagent consumption amount increases, and the cost is high. Meanwhile, an analysis apparatus according to the present invention is provided with: a flow cell used for analyzing samples; a sample container for containing a sample; a reagent container for containing a reagent; and a pressure generation mechanism for feeding the sample and the reagent to the flow cell through the flow passage, and also has an atmospheric opening in the flow passage of the flow cell on the upstream side.

### TECHNICAL FIELD

The present invention relates to an analysis apparatus. More specifically, the present invention relates to a method for supplying a reagent to a flow cell for decoding a base sequence of a nucleic acid, such as DNA or RNA, and a nucleic acid sequence analyzing apparatus.

### BACKGROUND ART

Various methods are employed for chemistry performed on a flow cell having a micro reaction field. The methods are fluorescence, pH, chemiluminescence, electrical measurement, and the like, but among these, the most promising method is a method which is called sequencing by synthesis (SBS) using the fluorescence method. The SBS is a method in which four types of nucleotides (dATP, dTTP, dCTP, and dGTP) labeled with four different types of fluorescent dyes are sequentially incorporated into the micro reaction field formed on a substrate, that is, one base at a time by using a polymerase. After one base has been incorporated, floating fluorescent nucleotides are removed by cleaning, and then fluorescence measurement is performed. The reason why elongation of the second base does not occur is that a substance that inhibits elongation of the second base dye is bound to the first base fluorescent dye. In addition, in order to perform the reaction of the minimum unit thereafter, after the fluorescence measurement, a step of cleaving the fluorescent dye and the elongation inhibiting substance from the base with a dissociation solution is indispensable. The step makes sequential continuation of the next base elongation reaction possible. By repeating the reaction by feeding the fluorescent nucleotide into the flow cell again, sequential sequencing becomes possible.

In the general SBS reaction process, the chemical reaction proceeds in a state where a substrate surface on which many micro reaction fields are disposed is wet. However, it is reported in PTL 1 that, even when the substrate surface is once dried, the following chemical reaction can proceed smoothly. In PTL 1, an SBS reaction is performed using fluorescently labeled nucleotides in a micro reaction field, but since the fluorescence measurement is performed by a scanner for microarray after incorporation of a fluorescent label, the drying is performed in order to remove the solution from the substrate and the fluorescence measurement for one base is performed. After this, the SBS reaction for the second base is resumed by dropping a reagent onto the substrate again. When the reaction of the second base is completed, the substrate is further dried and a fluorescence signal of the second base is measured with the scanner. By repeating this, the fluorescence signal is obtained, and according to this, it is possible to determine the base sequence of a template DNA fixed in the micro reaction field to 26 bases with high accuracy.

Similarly, it is reported in PTL 2 that, in a step of amplifying the micro reaction field on the substrate, even when the surface of the flow cell which is in a wet state is once dried, no problem occurs with respect to the chemical reaction of the following stage. PTL 2 describes a method of amplifying a sample DNA on the substrate. More specifically, after fixing the DNA sample onto the surface of the flow cell in Example, the reagent in the flow cell is suctioned by a vacuum pump and an in-flow cell flow passage is dried. After this, an amplification reagent is injected into the flow cell, the reaction is allowed to proceed for a certain period of time at an optimal reaction temperature, and the amplification reagent is suctioned by the vacuum pump. As described above, with respect to the flow cell surface, an amplification reaction on the flow cell substrate is achieved by repeating a plurality of times. In other words, it is reported that the chemical reaction can proceed even in the amplification reaction even through the step of drying the in-flow cell flow passage.

### CITATION LIST

### Patent Literature

PTL 1: WO2008/069973

PTL 2: US2013/0225421

### SUMMARY OF INVENTION

### Technical Problem

A conventional solution exchanging method in a next-generation sequencer needs a reagent amount three or more times greater than an in-flow cell flow passage volume in order to replace a reagent A in the flow cell with a new reagent B. Thus, the reagent consumption amount increases, and the cost is high.

### Solution to Problem

An analysis apparatus according to the present invention is provided with: a flow cell used for analyzing samples; a sample container for containing a sample; a reagent container for containing a reagent; and a pressure generation mechanism for feeding the sample and the reagent to the flow cell through the flow passage, and also has an atmospheric opening in the flow passage of the flow cell on the upstream side.

### Advantageous Effects of Invention

According to the present invention, a reagent consumption amount and reagent cost can be reduced. As a result, an effect that a reagent kit and a device size can be reduced is achieved.

### BRIEF DESCRIPTION OF DRAWINGS

FIG. 1 is a view illustrating a configuration of an analysis apparatus of the present invention.

FIG. 2 is a view illustrating a configuration around a flow cell of the analysis apparatus illustrated in FIG. 1.

FIG. 3 is a view for describing a step of feeding liquid to the flow cell illustrated in FIG. 2.

FIG. 4 is a view illustrating another variation of a configuration around the flow cell illustrated in FIG. 2.

FIG. 5 is a view illustrating another variation of the configuration around the flow cell illustrated in FIG. 2.

FIG. 6 is a view illustrating another variation of the configuration around the flow cell illustrated in FIG. 2.

FIG. 7 is a view illustrating another variation of the configuration around the flow cell illustrated in FIG. 2.

FIG. 8 is a view illustrating another variation of the configuration around the flow cell illustrated in FIG. 2.

FIG. 9 is a view illustrating another variation of the configuration around the flow cell illustrated in FIG. 2.

FIG. 10 is a view illustrating another variation of the configuration around the flow cell illustrated in FIG. 2.

FIG. 11 is a view illustrating another variation of the configuration around the flow cell illustrated in FIG. 2.

FIG. 12A is a view for describing a step of feeding liquid to the flow cell illustrated in FIG. 11.

FIG. 12B is a view for describing the step of feeding liquid to the flow cell illustrated in FIG. 11.

### DESCRIPTION OF EMBODIMENTS

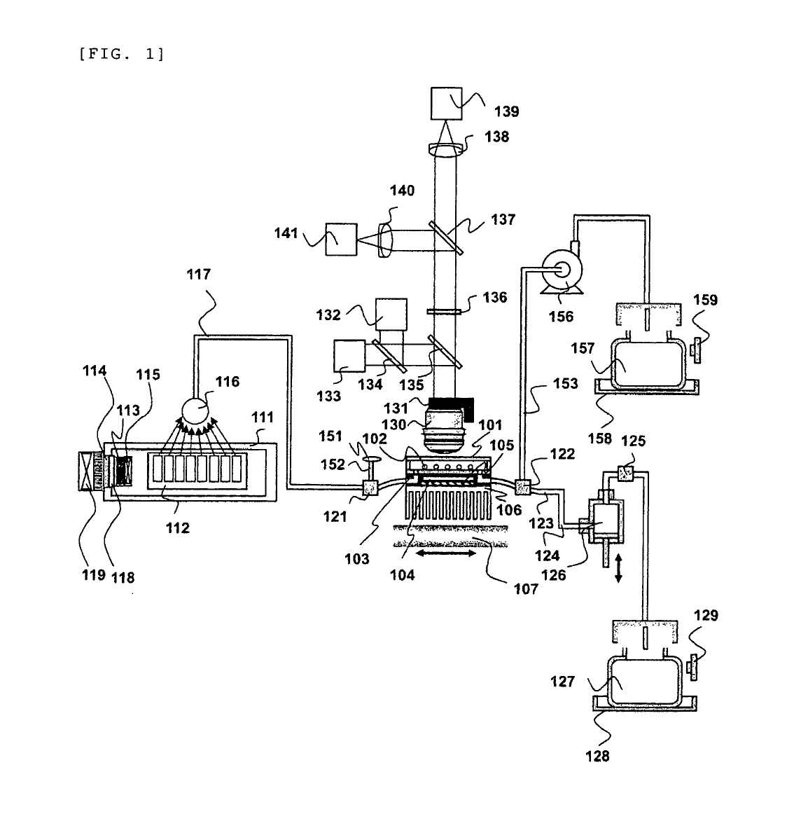

As First Example of the present invention, a sequence method for improving a reagent replacement efficiency and reducing a reagent amount by feeding and injecting a reagent necessary for a next reaction into an in-flow cell flow passage after selectively replacing the reagent that fills the in-flow cell flow passage with a gas, will be described with reference to FIG. 1.

A plurality of micro reaction fields 102 are disposed on a lower surface of a flow cell 101. The flow cell 101 is fixed to a heat block 103. A Peltier element 104 is disposed on the lower surface of the heat block 103 and the temperature of the flow cell 101 is adjusted. A temperature control range is 10° C. to 80° C. Temperature control is necessary for temperature adjustment in a chemical reaction, such as binding of a primer that serves as a reaction starting point in the micro reaction field 102 on the flow cell 101, incorporation reaction of a substrate with a primer as a scaffold, and cleaving of a protective group of a reaction substrate. A temperature measuring resistor (not illustrated) is inserted as a temperature sensor into the heat block 103 and used for feedback of the temperature control. A heat sink 106 which comes into contact with the Peltier element 104 via a thermal conduction sheet 105 dissipates heat generated by driving the Peltier element 104. The heat dissipation of the heat sink 106 is achieved by blowing the air to the heat sink 106 using a fan. Furthermore, the flow cell 101 is held by an XY stage 107, and can move the flow cell 101 horizontally in a plane on which an optical axis of an objective lens 130 is vertically incident. The objective lens 130 is fixed to a Z stage 131 and can move up and down in order to focus on a plurality of micro reaction fields 102 fixed to the surface of the flow cell 101. Although the objective lens 130 is usually an air gap, in order to achieve a higher resolution, it is also possible to employ a liquid immersion method for filling the space between the flow cell 101 and the objective lens 130 with pure water or oil.

A reagent for performing primer hybridization, an elongation reagent containing four types of fluorescent nucleotides, a cleaving reagent for dissociating the protective group of the fluorescent nucleotide, a cap reagent and a cleaning reagent for preventing an unnecessary reaction of a reactive group after the cleaving of the protective group, and the like are disposed and injected into a reagent cartridge 112 in advance. The reagent cartridge 112 is installed in a reagent rack 111 and cooled to approximately 4° C. A Peltier element 118 cools a heat block 114 installed in the reagent cartridge 112, and a fan 115 blows the air in the reagent rack 111 storage to a fin 113. The cooled air circulates inside the reagent rack 111 storage, and indirectly cools the plurality of reagents installed in the reagent cartridge 112 to 4° C.

A shipper tube is inserted to a bottom of each reagent well held in the reagent cartridge 112. It is possible to suction the reagent from a tip end of the shipper tubes. The shipper tube is connected to a switching valve 116. Selection can be performed by the switching valve 116, and an arbitrary reagent can be connected to a flow passage 117. The reagent selected by the switching valve 116 passes through the flow passage 117 and is fed to the flow cell 101 that holds the micro reaction field 102. A syringe pump 126 that serves as a power source for suctioning the reagent is disposed on the downstream side of the flow cell 101. A three-way valve 122 is disposed on the upstream side of the syringe pump 126, and a two-way valve 125 is disposed on the downstream side. When suctioning the reagent, the three-way valve 122 is controlled to connect the flow passage of the flow cell 101 and the syringe pump 126 to each other, and the two-way valve 125 is in a closed state to drive the syringe pump 126. In addition, in a case of discarding the reagent, the syringe pump 126 is driven by setting the three-way valve 122 to the closed state and the 125 to the open state, and the reagent is fed to a waste liquid tank 127. By the operation, it becomes possible to perform feeding of the plurality of reagents by one syringe pump 126. In addition, when the waste liquid tank 127 is not provided, the waste liquid may spill into an apparatus storage, and there is a possibility that a problem, such as electric shock, rust of the apparatus, and generation of offensive odor, occurs. In order to avoid this, it is necessary to dispose the waste liquid tank 127 in the apparatus, and in order to detect this, a micro photosensor 129 for monitoring the presence or absence of the waste liquid tank 127 is installed. Furthermore, for safety, a liquid receiving tray 128 is installed under the waste liquid tank 127 in a case where the waste liquid has leaked out.

The elongation reaction of a DNA chain is performed by reacting four types of nucleotides labeled with fluorescent dyes different from each other and a polymerase with the flow cell. Each nucleotide is FAM-dCTP, Cy3-dATP, Texas Red-dGTP, and Cy5-dTTP, respectively. The concentration of each nucleotide is 200 nM. In addition, salt concentration, magnesium concentration, and pH of a reaction liquid are optimized such that the elongation reaction can be performed efficiently. The polymerase is contained in the reaction solution, and the complementary fluorescent nucleotide is incorporated into a DNA fragment only by one base. The reason why elongation of the second base does not occur is that a substance that inhibits elongation of the second base dye is bound to the first base fluorescent dye. After one base has been incorporated, floating fluorescent nucleotides are removed by cleaning, and then fluorescence measurement is performed. In addition, in order to perform the reaction of the minimum unit thereafter, after the fluorescence measurement, a step of cleaving the fluorescent dye and a step of cleaving the elongation inhibiting substance, from the base with the dissociation solution is indispensable. The steps make sequential continuation of the next base elongation reaction possible. By repeating the reaction by feeding the fluorescent nucleotide into the flow cell again, sequential sequencing becomes possible. The reaction method employed in the present example is called sequence by synthesis.

The two LEDs 132 and 133 are light sources for exciting the fluorescent dye. The central wavelengths of the LEDs 132 and 133 are 490 and 595 nm, respectively. The LED 132 uses FAM-dCTP and Cy3-dATP, and the LED 133 uses Texas Red-dGTP and Cy5-dTTP for excitation light irradiation. A dichroic mirror 134 has a role of aligning light from the LEDs 132 and 133 on the same optical axis. Furthermore, the excitation light is made incident on a pupil surface of the objective lens 130 by a dichroic mirror 135. The micro reaction field 102 in the flow cell 101 is irradiated with the excitation light via the objective lens 130. The fluorescent dye incorporated into the micro reaction field 102 is excited and fluorescence is isotropically emitted. A part of the isotropically emitted fluorescence is condensed by the objective lens 130. Light which passes through the objective lens 130 becomes parallel light, passes through the dichroic mirror 135 and an emission filter 136, and advances straight to a dichroic mirror 137. Since the dichroic mirror 137 has gentle reflection characteristics for the four colors of fluorescence wavelength regions, fluorescence is divided into transmitted light and reflected light at different ratios in accordance with the fluorescence wavelength of the dye. The fluorescence transmitted through the dichroic mirror 137 passes through a condenser lens 138 and forms an image of the micro reaction field on a sensor surface of a CMOS camera 139. Similarly, the fluorescence reflected by the dichroic mirror 137 passes through a condenser lens 140 and forms an image of the micro reaction field on a sensor surface of a CMOS camera 141. By correlating the plurality of micro reaction fields to be imaged on the two CMOS cameras and calculating a fluorescence intensity ratio, it is possible to specify which of the four colors the fluorescent dye incorporated into each of the micro reaction fields has.

In addition, an area that can be observed by acquiring a single fluorescence image is a part of a region where the micro reaction field on the flow cell 101 exists, and specifically, the area is merely 1 mm square. This is a restriction derived from the number of fields of view of the objective lens and there is also a restriction of the number of micro reaction fields that can be measured for one imaging. Therefore, the XY stage 107 is used to observe the wider region of the flow cell 101. The flow cell 101 is moved in a plane direction perpendicular to the optical axis of the objective lens 130 at a pitch of 1 mm, for example. It is possible to perform fluorescence detection again with respect to the field of view 1 mm apart, to repeat the fluorescence detection with respect to adjacent fields of view, and to scan the entire region of the flow cell 101. Accordingly, fluorescence information, that is, base sequence information, can be acquired with respect to multiple micro reaction fields. After performing the fluorescence measurement on the entire surface of the flow cell 101, the elongation reaction for the next single base is performed with respect to the flow cell 101. Specifically, after the fluorescent dye in the micro reaction field 102 in the flow cell 101 is cleaved with the cleaving reagent and the inside of the flow cell is cleaned with a cleaning solution, the reagent containing the fluorescent nucleotide and the polymerase is fed again into the flow cell. After completing the chemical reaction, the fluorescence measurement is performed again with respect to the entire surface of the flow cell 101. By performing the chemical reactions and the fluorescence measurements for necessary bases, it is possible to acquire a large amount of base sequence analysis of the DNA to be measured.

The description so far is related to the sequence method using the fluorescence detection, but hereinafter, an apparatus configuration for improving the replacement efficiency of the reagent and reducing the reagent amount, which is a feature of the present example, will be described. More specifically, there are provided bypass flow passages 152 and 153 for selectively collecting and discarding only the reagent in the flow passage of the flow cell 101 without affecting the disposition and arrangement of the reagents that have already been fed into the tube of a reagent feeding system. In addition, three-way valves 121 and 122 are disposed at an intersection point between the bypass flow passage and the conventional reagent feeding system. The three-way valves 121 and 122 are positioned on the upstream and downstream sides of the flow cell 101. A vacuum pump 156 is connected to the downstream side of the bypass flow passage 153 and operates when it is desired to replace the reagent in the flow passage of the flow cell 101 with a gas. In addition, a filter 151 is installed on the upstream side of the bypass flow passage 152 in order to prevent suction of foreign matters in the gas. The reagent suctioned by the vacuum pump 156 is discarded to the waste liquid tank 157. Similar to the reagent feeding system, a micro photosensor 159 and a liquid receiving tray 158 are also installed in the bypass flow passage 156 in order to prevent liquid leakage.

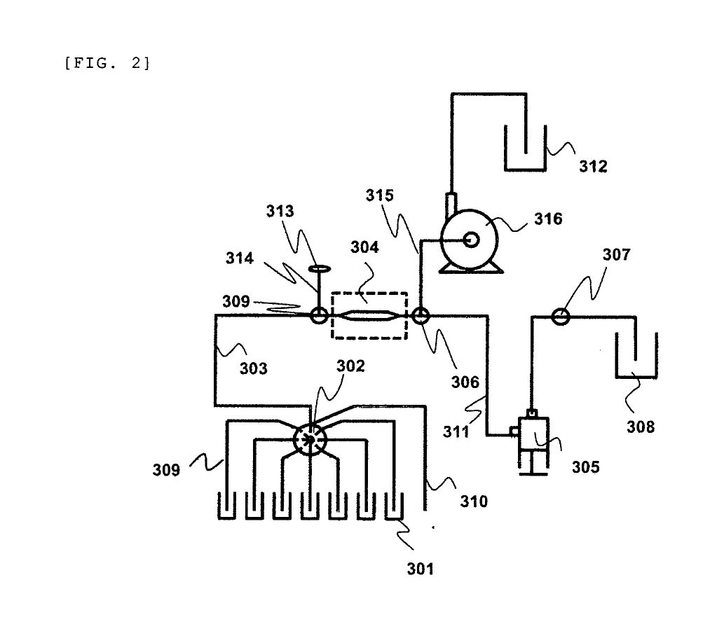

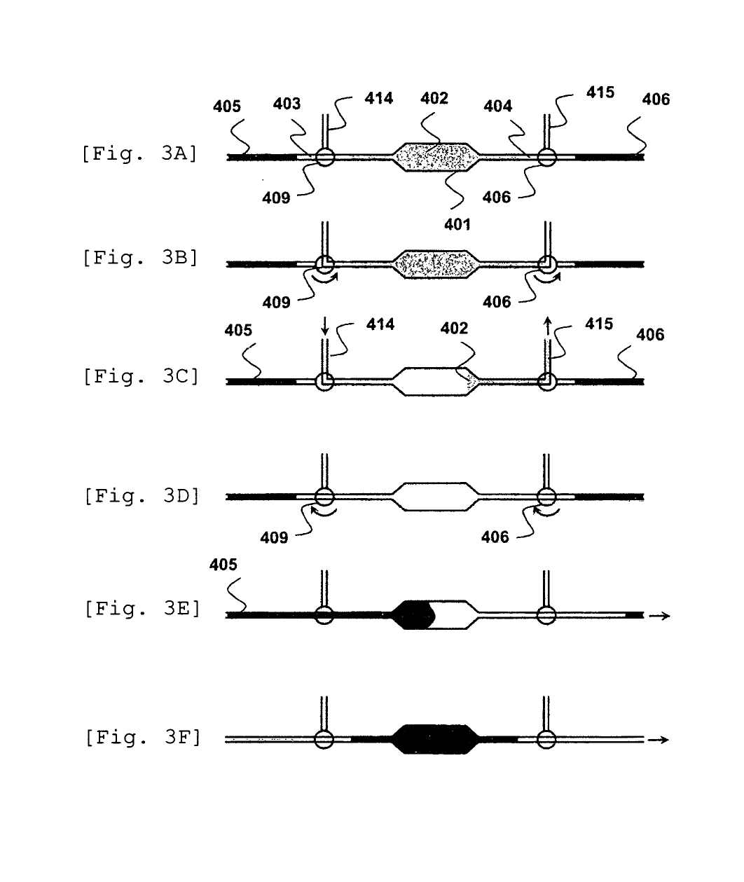

Next, as Second Example of the present invention, an apparatus and a method in which the bypass flow passage is formed by disposing switching valves on the upstream and downstream sides in the vicinity of the flow cell and the reagent replacement efficiency is improved by disposing the vacuum pump on the downstream side thereof, will be described with reference to FIGS. 2 and 3.

A plurality of reagents 301 are connected to a switching valve 302 via a shipper tube 321. The switching valve 302 is connected to a flow cell 304 via a flow passage 303 and is further connected to a flow passage 311 on the downstream side. The flow passage 311 is connected to a syringe pump 305 and discards the used reagent to the waste liquid tank 308. Here, an atmospheric opening tube 310 is for sandwiching the segmental air between the reagents for preventing contamination between the reagents generated by direct contact of different reagents. Here, in order to suction the reagent 301 to the flow cell 304 by using the syringe pump 305, in a state where a two-way valve 307 is closed, a three-way valve 306 is operated, and the flow passage in the flow cell 304 and the flow passage 311 are connected to each other, by operating the syringe pump 305, a negative pressure is generated. In addition, in a case of discarding the used reagent to the waste liquid tank 308, on the contrary, in a state where the three-way valve 306 is closed and the two-way valve 307 is open, by driving the syringe pump 305 and by generating a positive pressure, the discard of the reagent can be realized.

In addition to the above-described configuration, in the present example, a three-way valve 309 is newly disposed on the upstream side in the vicinity of the flow cell 304. Furthermore, bypass flow passages 314 and 315 are connected to the two three-way valves 309 and 306, a bypass flow passage is disposed separately from the flow passage used for conventional liquid feeding, and by using this, only the reagent that fills the flow cell 304 can be replaced with a gas selectively. In addition, a dust-proof filter is attached to an atmospheric opening end of the bypass flow passage 314. Accordingly, it is possible to prevent foreign matters from entering the flow cell 304.

What is noteworthy here is that only the reagent that fills the flow cell 304 can be selectively discarded while maintaining a state of the plurality of reagents disposed via the segmental air in the conventional reagent feeding flow passage 303. Amore specific method will be described with reference to FIG. 3.

In FIG. 3(a), a reagent A406, a reagent B402, and a reagent C405 are disposed in a tube and a flow passage of a flow cell 401 via segmental air 403 and 404. When the reagent B402 fills the flow passage in the flow cell 401, the liquid is fed such that the segmental air 403 and 404 are disposed on three-way valves 409 and 406. The three-way valves 409 and 406 are connected to bypass flow passages 414 and 415, respectively, in addition to the flow passage for general liquid feeding.

Next, a method for improving the reagent replacement rate in the flow cell 401 by selectively discharging the reagent B402 in the flow passage of the flow cell 401, will be specifically described. By switching the three-way valves 409 and 406 in FIG. 3(b), the upstream side flow passage and the downstream side flow passage of the flow cell 401 connected to the liquid feeding flow passage in which the reagent C405 and the reagent A406 exist, are connected to the bypass flow passages 414 and 415. Next, by using the vacuum pump connected to the downstream side of the bypass flow passage 415 in FIG. 3(c), the reagent B402 in the flow cell 401 is suctioned, and the reagent B is collected and discarded. In (c), the reagent in the flow passage in the flow cell 401 is completely replaced with the air. A liquid suction speed of the vacuum pump used at this time is approximately 4000 uL/sec. This is high speed and large capacity as compared with the suction speed of 10 uL/sec in the syringe pump or the like, and it is effective for completely drying a streak of the reagent B402 that remains on a bottom surface of the flow passage of the flow cell 401 after suctioning the reagent B402. When the reagent C405 is fed into the flow cell 401 in a state where the streak of the reagent B402 remains, the reagent C405 wraps up the air, and as a result, since this causes generation of air bubbles in the flow passage of the flow cell 401, it is desirable that the streak is dried as completely as possible. Next, in FIG. 3(d), the three-way valves 409 and 406 are again connected to the liquid feeding flow passage in which the reagent C405 and the reagent A406 exist. Next, in a state of (e), the reagent A406 and the reagent C405 are suctioned using the syringe pump 305 on the downstream side of the liquid feeding flow passage. The reagent 0405 enters the completely dried flow passage of the flow cell 401 and fills the flow cell 401 without chewing the air bubbles. In a case of the present example, since the reagent B402 which exists before the replacement is completely suctioned, contamination of the reagent B402 to the reagent C405 does not occur. In replacing the reagent in the conventional flow cell, the contact between the liquid and the liquid occurs. However, the behavior of the fluid in the flow cell is a laminar flow, and it has been found that replacement between two different liquids is extremely difficult to mix. Moreover, in the present example, since the micro reaction field in which the reaction proceeds is fixed to a substrate surface, the efficiency of the reagent replacement is particularly not excellent. Therefore, conventionally, in reagent replacement in the in-flow cell flow passage, the reagent replacement is generally empirically performed with the reagent amount which is at least three times the content of the flow cell. Generally, it is extremely difficult to analytically calculate a feed volume required for replacing the reagent. This is because the calculation also depends on the shape (width, length, and height of the flow passage) of the flow cell, the viscosity or surface tension of the reagent to be used, the speed of the fluid at the time of feeding, temperature conditions, and the like. Therefore, in practice, it is necessary to experimentally estimate the amount of liquid required for reagent replacement in each intrinsic system, and empirically the reagent replacement amount required for this is three or more times.

As a result, in a case where the flow cell capacity is 10 uL, while 60 uL (=10+10+30+10 uL) is necessary for replacing the reagent in the conventional method, in the present example, it is possible to reduce the necessary capacity to 30 uL (=10+10+10 uL) which is a half of that in the conventional method. Meanwhile, as the flow cell capacity becomes larger than 10 uL, the effect of reducing the reagent consumption amount approaches ¼.

When the bypass flow passage is provided in the vicinity of the flow passage of the flow cell described in the present example and only the reagent of the in-flow cell flow passage can be selectively replaced with a gas via the bypass flow passage, it is also possible to replace the reagent on the surface of the flow cell on which the reagent replacement on the surface of the flow cell is unlikely to proceed with a gas. After this, the reagent necessary for the next reaction may be fed again substantially by a liquid volume of the in-flow cell flow passage. As a result, it becomes possible to reduce the reagent amount which is necessary for the reagent replacement.

In addition, although the suction depends on the chemical treatment state of the surface of the flow passage of the flow cell, it is desirable that the suction by the vacuum pump is performed at less than 35 KPa in consideration of damage to chemical modification of the surface. In addition, in order not to leave droplets of the reagent in the flow passage of the flow cell, it is desirable to dispose a pressure generating device which is capable of generating a negative pressure on the downstream side of the flow passage of the flow cell as described in the present example, and to suction the reagent. Conversely, in a case where the pressure generating device is disposed on the upstream side of the flow passage of the flow cell and a positive pressure is applied to the flow passage of the flow cell, a problem that the reagent in the flow passage of the flow cell cracks and remains on the surface of the flow passage of the flow cell in a droplet state also occurs.

Further, it is also possible to monitor and confirm a dry state in the flow passage of the flow cell with an optical detection system via the objective lens. Specifically, it is possible to confirm this by a scattering image of the remaining reagent. In addition, in order to improve the detection sensitivity, by dissolving the fluorescent dye having different excitation and detection wavelengths from those of the four types of the fluorescent dyes used for sequencing in the reagent in advance, it is possible to more reliably monitor a state where the reagent is replaced with a gas on the flow cell. In addition, in order to accelerate the drying of the reagent, the temperature of the heat block for fixing the flow cell can also be heated within a range of 35° C. to 65° C.

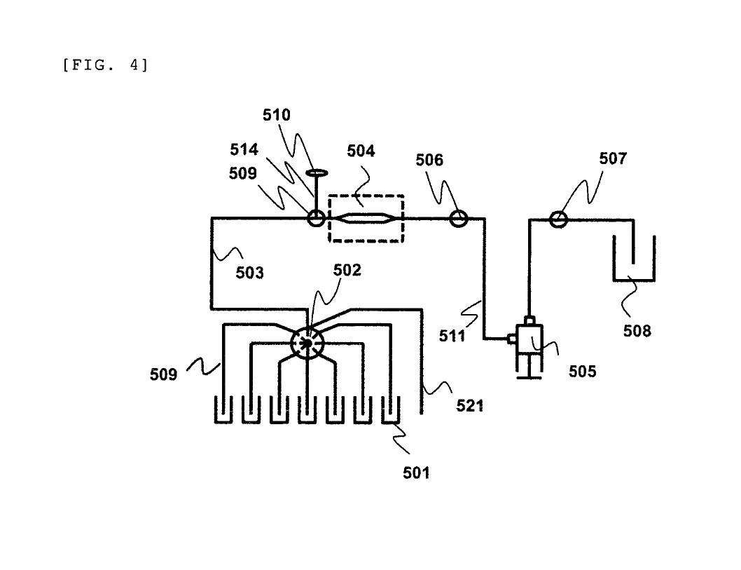

Next, as Third Example of the present invention, an apparatus and a method in which the bypass flow passage is formed by disposing the switching valve on the upstream side in the vicinity of the flow cell and the reagent replacement efficiency is improved by using the syringe pump disposed on the downstream side for the conventional reagent feeding, will be described with reference to FIG. 4.

A plurality of reagents 501 are connected to a switching valve 502 via a shipper tube 509. The switching valve 502 is connected to a flow cell 504 via a flow passage 503 and is further connected to a flow passage 511 on the downstream side. The flow passage 511 is connected to a syringe pump 505 and discards the used reagent to a waste liquid tank 508. Here, an atmospheric opening tube 521 is for sandwiching the segmental air between the reagents for preventing contamination between the reagents generated by direct contact of different reagents. In addition, in order to suction the reagent 501 to the flow cell 504 by using the syringe pump 502, in a state where a two-way valve 507 is closed, a two-way valve 506 is open, and the three-way valve 509 connects the flow passage 503 and the flow passage in the flow cell 504 to each other, by operating the syringe pump 505, a negative pressure is generated. In addition, in a case of discarding the used reagent to the waste liquid tank 508, on the contrary, the two-way valve 506 is closed, the two-way valve 507 is open, and by generating a positive pressure by the syringe pump 505, the discard of the reagent can be realized. Here, the three-way valve 509 is disposed in the vicinity of the flow cell 504, and it is possible to perform switching freely by connecting the normal liquid feeding flow passage 503 and a bypass flow passage 514 to each other. The expensive reagent A currently fills the flow passage of the flow cell 504. In addition, the expensive reagent B stays in the flow passage 503 via the reagent A and the segmental air. Next, by replacing the reagent in the flow passage in the flow cell 504 from the reagent A to the reagent B, it is possible to proceed the chemical reaction in the micro reaction field fixed to the bottom surface of the flow passage in the flow cell 504. At this time, by operating the three-way valve 509 and connecting the flow passage in the flow cell 504 and the bypass flow passage 514 to each other, the upstream side of the flow cell 504 can be opened to the atmosphere. In this state, by opening the two-way valves 506 and 507 and suctioning the syringe pump 505, it becomes possible to replace the reagent A in the flow cell 504 with a gas, specifically with the air. After replacing the reagent in the flow passage of the flow cell 504 with the air, by switching the three-way valve 509, the liquid feeding flow passage 503 and the flow passage in the flow cell 504 are connected to each other, and by further driving the syringe pump, the reagent B can be introduced to the flow passage in the flow cell 504. Since the reagent A in the micro reaction field on the surface of the bottom surface of the flow cell 504 is completely replaced with the air, the reagent B is in a form in which factors that interfere with the reaction, such as contamination with the reagent A or concentration reduction of the reagent B are excluded, and it becomes possible to supply the reagent B into the flow passage of the flow cell 504. A noteworthy effect is an effect that the amount of the reagent B can be reduced from the amount of supply of the reagent B to the extent that a liquid feed error amount of the apparatus is added to a solution holding volume in the flow passage of the flow cell 504. In the conventional method, since the reagent in the flow cell 504 behaves as a laminar flow, replacement of the reagent A and the reagent B does not proceed smoothly. Therefore, generally, in order to replace the reagent, a reagent amount (60 uL=10×2 uL+10×4 uL when the flow cell capacity is 10 uL) of liquid feed error amount×2+reagent holding volume in flow passage of flow cell 504×4 is necessary, but in the present example, it is possible to reduce the reagent amount to a reagent amount of liquid feed error amount×2+reagent holding volume in flow passage of flow cell 504×1. Furthermore, the feature of the present example is that the reagent amount can be reduced with a simple and inexpensive apparatus configuration in which only the three-way valve 509, the bypass flow passage 514, and a dust-proof filter 510 are added to the conventional configuration described in Example 2.

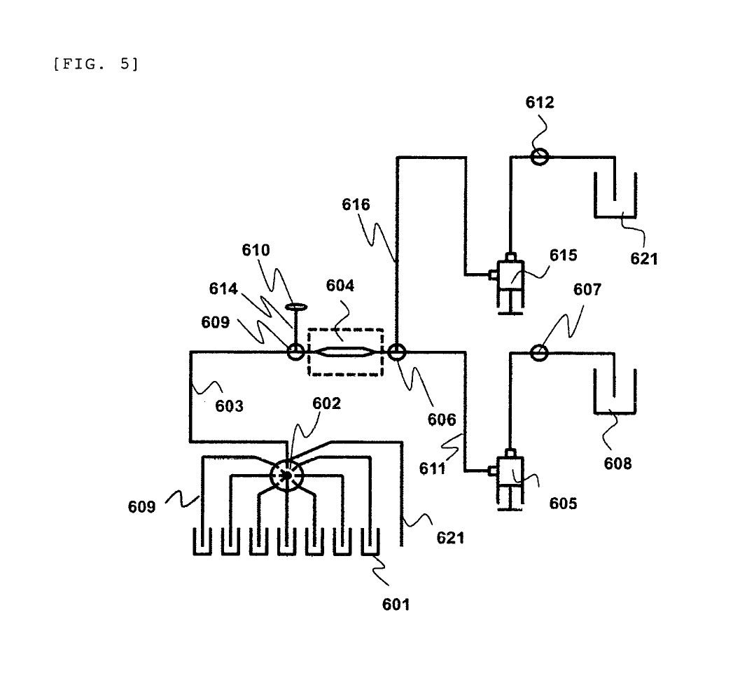

Next, as Fourth Example of the present invention, an apparatus and a method in which the bypass flow passage is formed by disposing switching valves on the upstream and downstream sides in the vicinity of the flow cell and the reagent replacement efficiency is improved by disposing the syringe pump on the downstream side thereof, will be described with reference to FIG. 5.

The present example has a configuration similar to the apparatus configuration described in FIG. 2 in Example 2. Specifically, regarding the pressure generating device disposed on the downstream side of the bypass flow passage, while the vacuum pump is employed in Example 2, a syringe pump 615 is employed in the present example (FIG. 5). More specifically, a plurality of reagents 601 are connected to a switching valve 602 via a shipper tube 609. The switching valve 602 is connected to a flow cell 604 via a flow passage 603 and is further connected to a flow passage 611 on the downstream side. The flow passage 611 is connected to a syringe pump 605 and discards the used reagent to a waste liquid tank 608. Here, an atmospheric opening tube 621 is for sandwiching the segmental air between the reagents for preventing contamination between the reagents generated by direct contact of different reagents. Here, in order to suction the reagent 601 to the flow cell 604 by using the syringe pump 605, in a state where a two-way valve 607 is open and a three-way valve 606 is connected to the flow passage in the flow cell 604, by operating the syringe pump 605, a negative pressure is generated. In addition, in a case of discarding the used reagent to the waste liquid tank 608, on the contrary, the three-way valve 606 is closed, the two-way valve 607 is open, and by generating a positive pressure by the syringe pump 305, the discard of the reagent can be realized.

Next, a method for discarding only the reagent in the flow cell 604 and replacing the reagent in the flow cell 604 with the air while maintaining the arrangement state of the plurality of adjacent reagents in the flow passage 603 via the segmental air will be described below. The three-way valve 609 is operated, and a bypass flow passage 614 and the flow passage in the flow cell 604 arc connected to each other. Similarly, the three-way valve 606 is operated, and the flow passage in the flow cell 604 and a bypass flow passage 616 are connected to each other. In a state where the two-way valve 612 is closed, by suctioning the syringe pump 615, a negative pressure is set in the bypass flow passage 616, and it is possible to selectively suction the reagent in the flow cell 604 and to collect the reagent. Accordingly, the reagent in the flow passage in the flow cell 604 is replaced with the air and the flow passage is in a dry state. In addition, since the air is suctioned via a filter 610, foreign matters which float in the air does not enter the flow cell 604. Next, the three-way valves 609 and 606 are operated and the flow passage 603 and the flow passage in the flow cell 604, and the flow passage in the flow cell 604 and the flow passage 611 are connected to each other, respectively. In a state where the two-way valve 607 is closed, by driving the syringe pump 605, it is possible to suction the reagent which has already been disposed in the flow passage 603 into the flow passage in the flow cell 604 that is in a dry state. On the flow cell 604 which is in a dry state, no pre-reagent that interferes with the replacement of the reagent remains on the surface, and thus, it becomes possible to efficiently replace the reagent.

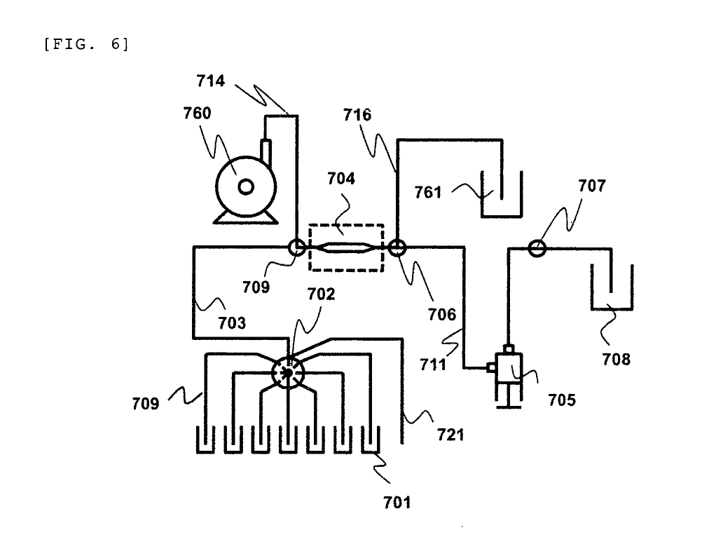

Next, as Fifth Example of the present invention, an apparatus and a method in which the bypass flow passage is formed by disposing switching valves on the upstream and downstream sides in the vicinity of the flow cell and the reagent replacement efficiency is improved by disposing the vacuum pump on the upstream side thereof, will be described with reference to FIG. 6.

The present example has a configuration similar to the apparatus configuration described in FIG. 2 in Example 2. Specifically, in Example 2, the vacuum pump is disposed on the downstream side of the bypass flow passage, but in the present example, the vacuum pump is disposed on the upstream side of the bypass flow passage.

Similar to the apparatus described in FIG. 2 in Example 2, a plurality of reagents 701 are connected to a switching valve 702 via a shipper tube 709. The switching valve 702 is connected to a flow cell 704 via a flow passage 703 and is further connected to a flow passage 711 on the downstream side. The flow passage 711 is connected to a syringe pump 705 and discards the used reagent to a waste liquid tank 708. Here, an atmospheric opening tube 721 is for sandwiching the segmental air between the reagents for preventing contamination between the reagents generated by direct contact of different reagents. In addition, in order to suction the reagent 701 to the flow cell 704 by using the syringe pump 707, a two-way valve 707 is closed, a three-way valve 706 is operated, the flow passage in the flow cell 704 and the flow passage 711 are connected to each other, similarly, the three-way valve 709 is operated, the flow passage 703 and the flow passage in the flow cell 704 are connected to each other, and by operating the syringe pump 705, a negative pressure is generated. In addition, in a case of discarding the used reagent to the waste liquid tank 708, on the coiiLrary, the three-way valve 706 is closed, the two-way valve 707 is open, and by generating a positive pressure by the syringe pump 705, the discard of the reagent can be realized. Here, the three-way valve 709 is disposed in the vicinity of the flow cell 704, and it is possible to perform switching freely by connecting the normal liquid feeding flow passage 703 and a bypass flow passage 714 to each other. Similarly, the three-way valve 706 is disposed in the vicinity of the flow cell 704, and it is possible to connect the normal flow passage in the flow cell 704 and the liquid feeding flow passage 711 or a bypass flow passage 716 to each other. The expensive reagent A currently fills the flow passage of the flow cell 704. In addition, the expensive reagent B stays in the flow passage 703 via the segmental air together with the reagent A. Next, by replacing the reagent in the flow passage in the flow cell 704 from the reagent A to the reagent B, it is possible to proceed the chemical reaction in the micro reaction field fixed to the bottom surface of the flow passage in the flow cell 704. At this time, by operating the three-way valve 709 and connecting the flow passage in the flow cell 704 and the bypass flow passage 714 to each other, the upstream side of the flow cell 704 can be opened to the atmosphere. Similarly, the three-way valve 706 is operated, and the flow passage in the flow cell 704 and a bypass flow passage 716 are connected to each other. By driving a vacuum pump 760, it becomes possible to replace the reagent A in the flow cell 704 with a gas, specifically with the air. After replacing the reagent in the flow passage of the flow cell 704 with the air, by switching the three-way valves 709 and 706, the liquid feeding flow passage 703 and the flow passage in the flow cell 704, and the flow passage 711 and the flow passage in the flow cell 704 are connected to each other, and by further driving the syringe pump 705, the reagent B can be introduced to the flow passage in the flow cell 704. Since the reagent A in the micro reaction field on the surface of the bottom surface of the flow cell 704 is completely replaced with the air, the reagent B is in a form in which factors that interfere with the reaction, such as contamination with the reagent A or concentration reduction of the reagent B are excluded, and it becomes possible to supply the reagent B into the flow passage of the flow cell 704. A noteworthy effect is an effect that the amount of the reagent B can be reduced from the amount of supply of the reagent B to the extent that the liquid feed error amount of the apparatus is added to the solution holding volume in the flow passage of the flow cell 704. In the conventional method, since the reagent in the flow cell 704 behaves as a laminar flow, replacement of the reagent A and the reagent B does not proceed smoothly. Therefore, generally, in order to replace the reagent, the reagent amount (60 uL=10×2 uL+10×uL when the flow cell capacity is 10 uL) of liquid feed error amount x 2 +reagent holding volume in flow passage of flow cell 704×4 is necessary, but in the present example, it is possible to reduce the reagent amount to a reagent amount of liquid feed error amount×2+reagent holding volume in flow passage of flow cell 704×1.

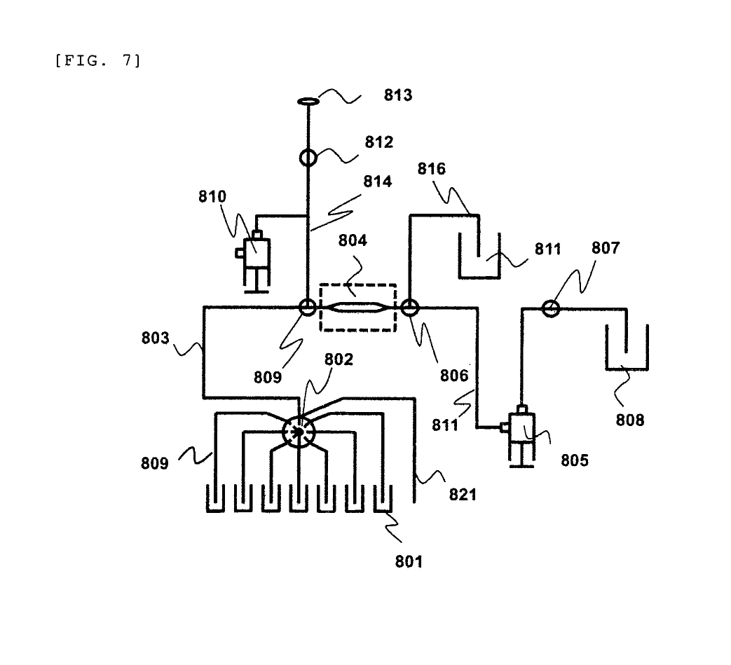

Next, as Sixth Example of the present invention, an apparatus and a method in which the bypass flow passage is formed by disposing switching valves on the upstream and downstream sides in the vicinity of the flow cell and the reagent replacement efficiency is improved by disposing the syringe pump on the upstream side thereof, will be described with reference to FIG. 7.

The present example has a configuration similar to the apparatus configuration described in FIG. 2 in Example 2. Specifically, in Example 2, the vacuum pump is disposed on the downstream side of the bypass flow passage, but in the present example, the syringe pump is disposed on the upstream side of the bypass flow passage. By using the present example, by selectively replacing the reagent in the flow passage in a flow cell 804 with the air and by feeding the reagent disposed in a flow passage 803 to the flow passage in the flow cell 804, it becomes possible to perform reagent replacement with fewer reagent amount in the flow passage of the flow cell 804.

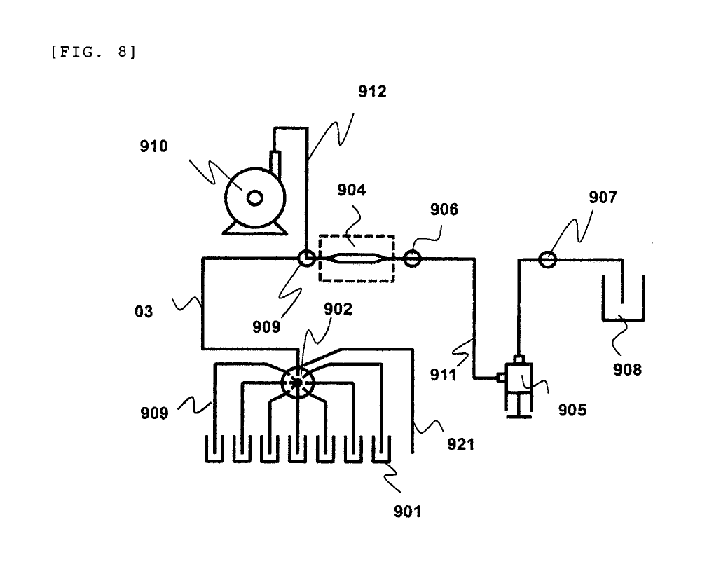

Next, as Seventh Example of the present invention, an apparatus and a method in which the bypass flow passage is formed by disposing switching valves on the upstream and downstream sides in the vicinity of the flow cell and the reagent replacement efficiency is improved by disposing the vacuum pump on the upstream side thereof, will be described with reference to FIG. 8.

The present example has a configuration similar to the apparatus configuration described in FIG. 4 in Example 3. Specifically, in Example 3, the pressure generation mechanism is not disposed in the bypass flow passage on the upstream side, but in the present example, a three-way valve 909 and a two-way valve 906 are disposed in the vicinity of the flow cell 904. In addition, a bypass flow passage 912 connected to the three-way valve 909 and a vacuum pump 910 on the upstream side of the bypass flow passage 912 are disposed. Accordingly, a configuration that can positively replace the reagent of the flow passage in the flow cell 904 with a gas is realized.

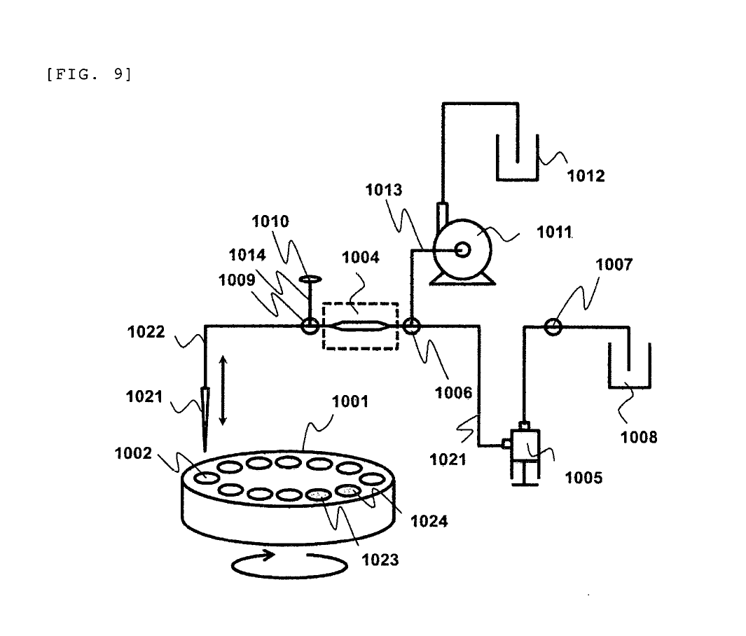

Next, as Eighth Example of the present invention, an apparatus and a method in which the bypass flow passage is formed by disposing switching valves on the upstream and downstream sides in the vicinity of the flow cell and the reagent replacement efficiency is improved by disposing the vacuum pump on the downstream side thereof, will be described with reference to FIG. 9.

The present example has a configuration similar to the apparatus configuration described in FIG. 2 in Example 2. Specifically, in Example 2, by immersing a shipper tube 209 in a reagent 201 and by driving the switching valve 309, the type of reagent to be suctioned into the flow passage 303 is determined. In the present example, instead of this, a method for suctioning and feeding the reagent by a nozzle 1021 is employed.

More specifically, a reagent cartridge 1001 has a structure that can hold a plurality of reagents 1002. The reagent cartridge 1001 can dispose the plurality of reagents 1002 in a circumferential direction thereof and can rotate in the circumferential direction by a motor. The nozzle 1021 can be driven in a Z direction by the motor. Therefore, the nozzle 1021 can access the plurality of different reagents 1002, and it is possible to suction and feed arbitrary reagent 1002 to a flow passage 1022 via a syringe pump 1005 on the downstream side of the flow passage. In a case of suctioning the reagent 1021 having different compositions, there is a concern that contamination occurs in which the reagent 1002 attached to an outer wall of the nozzle 1021 is carried into different reagents 1002. Therefore, by disposing a plurality of cleaning tanks 1023 and 1024 in the reagent cartridge 1001 and by immersing the nozzle 1021 in the cleaning tank a plurality of times, it is possible to reduce a carry-in amount of the pre-reagent with respect to the different reagents 1002 to be 0.1% or less. As a result, the contamination between the reagents 1002 can be reduced to a concentration that does not affect the analytical performance. In addition, the segmental air can be sandwiched between the reagents so as to avoid contact between the different reagents 1002 in the flow passage 1022 during the feeding. More specifically, in a state where the nozzle 1021 is held in the air, an arbitrary amount of air is suctioned, and then different reagents 1002 are suctioned. Accordingly, it is possible to realize the liquid feeding function similar to that of Example 2 with the configuration of the present example.

Further, similarly to the apparatus described in FIG. 2 in Example 2, the flow passage 1022 after the nozzle 1021 is connected to the flow passage in a flow cell 1004. The flow passage in the flow cell 1004 is connected to the flow passage 1021 further on the downstream side. The flow passage 1021 can be connected to a syringe pump 1005 and can discard the used reagent 1002 to a waste liquid tank 1008. In order to suction the reagent 1002 to the flow cell 1004 by using the syringe pump 1005, by bringing the nozzle 1021 into contact with the inside of the reagent 1002 and by driving a three-way valve 1009, the flow passage 1022 and the flow passage in the flow cell 1004 are connected to each other, and by further driving a three-way valve 1006, a state where the flow passage in the flow cell 1004 is connected to the flow passage 1021 and a two-way valve 1007 is closed is achieved. In this state, by generating a negative pressure by operating the syringe pump 1005, it is possible to suction the reagent 1002. In addition, in a case of discarding the used reagent 1002 to the waste liquid tank 1008, on the contrary, in a state where the three-way valve 1006 is closed and the two-way valve 1007 is open, by generating a positive pressure by the syringe pump 1005, the discard of the used reagent 1002 can be realized.

In order to selectively collect and discard only the reagents in the flow passage in the flow cell 1004 without changing to the state of the plurality of reagents fed and arranged via the segmental air to the flow passage 1022, the following method is used. In other words, the reagent in the flow cell 1004 is partitioned from the adjacent reagents by the segmental air. When the reagent stays in the flow passage in the flow cell 1004, the segmental air adjacent to both ends of the reagent stays in the three-way valve 1009 and the three-way valve 1006 which are branch points of the flow passage, respectively. In the above-described state, by driving the three-way valve 1009, a bypass flow passage 1014 and the flow passage in the flow cell 1004 are connected to each other, and by further driving the three-way valve 1006, a bypass flow passage 1013 and the flow passage in the flow cell 1004 are connected to each other. In this state, by driving a vacuum pump 1011 disposed on the downstream side of the bypass flow passage 1013, without changing to the arrangement state of the plurality of reagents 1002 which are already suctioned and fed to the flow passage 1022, it is possible to selectively suction and to collect only the reagent in the flow cell 1004. The collected reagent is discarded to a waste liquid tank 1012. In addition, the reagent in the flow passage in the flow cell 1004 is once completely replaced with a gas. After this, by driving the three-way valve 1009, the flow passage 1022 and the flow passage in the flow cell 1004 are connected to each other again, and by further driving the three-way valve 1006, the flow passage 1021 and the flow passage in the flow cell 1004 are connected to each other again. In addition, in a state where the two-way valve 1007 is closed, by driving the syringe pump 1005, it is possible to introduce a new reagent to the flow passage in the flow cell 1004. Since the reagent in the micro reaction field on the surface of the bottom surface of the flow cell 1004 is completely replaced with the air, the new reagent is in a form in which factors that interfere with the reaction, such as contamination with the pre-reagent or concentration reduction of the new reagent are excluded, and it becomes possible to supply the new reagent into the flow passage of the flow cell 1004. A noteworthy effect is an effect that the amount of new reagent can be reduced from the amount of supply of new reagent to the extent that the liquid feed error amount of the apparatus is added to the solution holding volume in the flow passage of the flow cell 1004. In the conventional method, since the reagent in the flow cell 1004 behaves as a laminar flow, replacement of the old reagent and the new reagent does not proceed smoothly. Therefore, generally, in order to replace the reagent, the reagent amount (60 uL=10×2 uL+10×4 uL when the flow cell capacity is 10 uL) of liquid feed error amount×2+reagent holding volume in flow passage of flow cell 1004×4 is necessary, but in the present example, it is possible to reduce the reagent amount to a reagent amount of liquid feed error amount×2+reagent holding volume in flow passage of flow cell 1004×1.

It is also possible to employ the present example to a biochemical automatic analysis apparatus and an immunity automatic analysis apparatus. In particular, the immunity automatic analysis apparatus detects antigens in a biological sample by utilizing antigen and antibody reaction. For example, a solid attached with a label, such as a fluorescent molecule or a complex in a small reaction container, is reacted with an antigen in the sample, a magnetic particle suspension of micrometer order is added and mixed, and the reactant is held on a particle surface. Next, the reaction liquid is suctioned into the flow passage for detection, a magnet is brought to be close to the flow cell provided in the middle of the flow passage, the particles at a detection position on an inner surface of the flow cell are washed out, and the particles are discharged to the waste liquid tank on the downstream side. In a case of replacing the reagent in the flow cell, the segmental air is suctioned between the reagents, and the reagents before and after are not mixed with each other. Even in the current immunity automatic analysis apparatus, the reagent amount which is three or more times greater than the flow cell capacity is required for the reagent replacement in the flow cell, but by providing the bypass flow passage described in the present example, and by selectively replacing the reagent in the flow cell, it is possible to reduce the reagent amount.

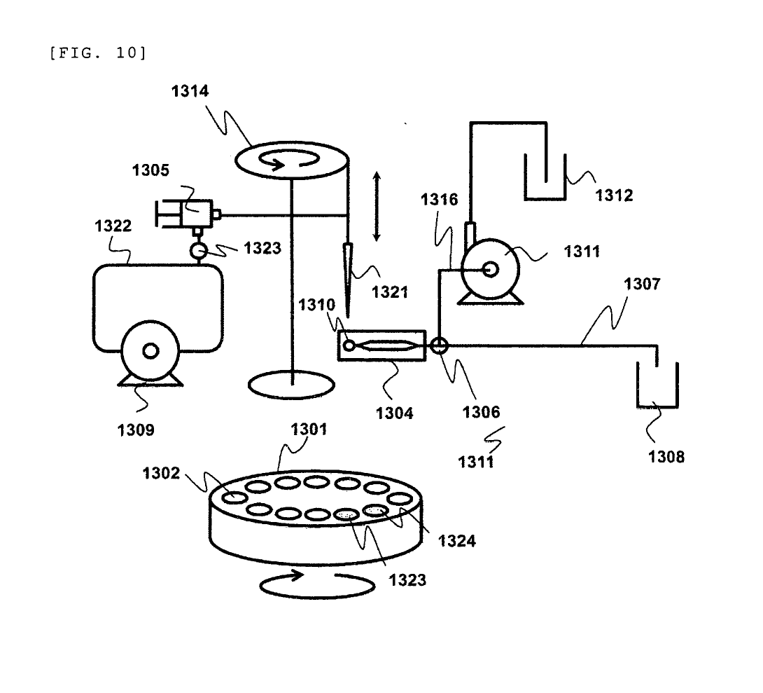

Next, as Ninth Example of the present invention, an apparatus and a method in which the bypass flow passage is formed by directly injecting the reagent to the flow cell by a direct injection method using the nozzle and by disposing switching valves on the downstream side in the vicinity of the flow cell, and the reagent replacement efficiency is improved by disposing the vacuum pump on the downstream side thereof, will be described with reference to FIG. 10.

A reagent cartridge 1301 has a structure that can hold a plurality of reagents 1302. The reagent cartridge 1301 can dispose the plurality of reagents 1302 in a circumferential direction thereof and can rotate in the circumferential direction by a motor. In the present example, a direct injection method is employed. The direct injection method is a method in which the reagent 1302 is injected into the flow passage of a flow cell 1304 by inserting a nozzle 1321 directly into a reagent injection port 1310 of the flow cell 1304. The nozzle 1321 can be driven in an up-down direction by the motor. Further, the nozzle 1321 can move in the horizontal direction by a rotation mechanism 1314. By the up-down movement and rotational movement, the nozzle 1321 moves between the reagent 1302 of the reagent cartridge 1301 and the injection port 1310 of the flow cell 1304, and accordingly, an arbitrary reagent 1302 can be injected into the injection port 1310 of a flow cell 1303. In addition, in a case of suctioning the reagents 1302 having different compositions, there is a concern that contamination occurs in which the reagent 1302 attached to an outer wall of the nozzle 1321 is carried into different reagents 1302. Therefore, by disposing a plurality of cleaning tanks 1323 and 1324 in the reagent cartridge 1301 and by immersing the nozzle 1321 in the cleaning tank a plurality of times, it is possible to reduce a carry-in amount of the pre-reagent with respect to different reagents 1302 to be 0.1% or less. As a result, the contamination between the reagents 1302 can be reduced to a concentration that does not affect the analytical performance.

Further, by operating the opening and closing of the two-way valve 1323, it is possible to suction and discharge the reagent 1302 by the nozzle 1321. In addition, a syringe pump 1305 is connected to a flow passage 1322 which drives a pump 1309 and continuously circulates system water. By using the system water, it is possible to fill the nozzle flow passage with pure water, and thus, it is possible to eliminate the influence of a damper due to the gas that serves as an elastic body, and to achieve high suction accuracy and suction reproducibility. In addition, it becomes possible to easily clean the inside of the nozzle, and it is possible to prevent contamination that may occur at the time of suctioning the reagent 1302. The reagent 1302 inserted in the flow passage of the flow cell 1304 is discarded to a flow passage 1316 or a flow passage 1307 in accordance with the reagent cost. In a case where the reagent 1302 is expensive, a three-way valve 1306 is operated and the in-flow cell flow passage 1304 and a flow passage 1316 are connected to each other. In this state, by driving a vacuum pump 1311, it becomes possible to selectively replace the reagent 1302 that fills the flow passage in the flow cell 1304 with the air. In addition, in a case where the reagent is inexpensive, the flow passage in the flow cell 1304 and the flow passage 1307 are connected to each other using the three-way valve 1306. In this case, an inexpensive reagent can be injected from the injection port 1310 through the nozzle 1321, and the reagent replacement in the flow passage in the flow cell 1304 can be achieved. In addition, while a discharge speed of the nozzle 1321 is merely 10 uL/sec, the liquid and gas suction speed of the vacuum pump 1311 is approximately 4000 uL/sec. Therefore, compared to the nozzle 1321, the reagent replacement via the vacuum pump 1316 is faster and the surface of the flow cell 1304 can be further dried completely without residues, such as droplets, and thus, it becomes possible to achieve higher reagent replacement efficiency. In other words, by using the vacuum pump 1316, it becomes possible to reduce the reagent consumption amount, particularly the consumption amount of expensive reagents.

A particular advantage in the present example is that contamination of a minute amount of sample adhering to the flow passage on the upstream side of the flow passage of the flow cell 1304 can be avoided. In a case where a sample DNA is fed onto the flow cell 1304 via the flow passage, such as a conventional tube, and an amplification reaction is performed on the flow cell 1304, there is a problem that the sample DNA is adsorbed to the inside of the flow passage wall surface. In a case where the next new measurement is performed, the sample DNA is fed into the flow passage of the flow cell 1304 as contamination, is amplified, and causes serious noise. Although protocols have been developed to eliminate the sample DNA by flow passage cleaning for each measurement, the problem is still plaguing the measurer as a serious problem. Regarding the contamination problem, when the method in which the conventional switching valve is used is employed, the flow passage to the flow cell becomes as long as at least 300 mm or more. In addition, it is necessary to insert the shipper tube into the sample DNA solution during the measurement, but since it is difficult to replace the shipper tube every measurement as a consumable item, this also causes contamination. In the present example, since the sample is fed only via a short flow passage system in the vicinity of the nozzle 1321, contamination can be suppressed to be extremely small. In addition, after suctioning the sample DNA and the reagent, a cleaning operation inside the nozzle which discharges the sample DNA and the reagent immediately with the system water is also added, and thus, contamination can be kept extremely small. In addition, since the cleaning may be performed only with respect to the flow passage in the vicinity of the nozzle 1321, it becomes possible to reduce amplification noise generated by the remaining sample. Further, since the nozzle is made of metal while the conventional flow passage is a resin tube, a stronger cleaning, such as a stronger alkali cleaning, can be employed in cleaning at the time of maintenance after the measurement is finished.

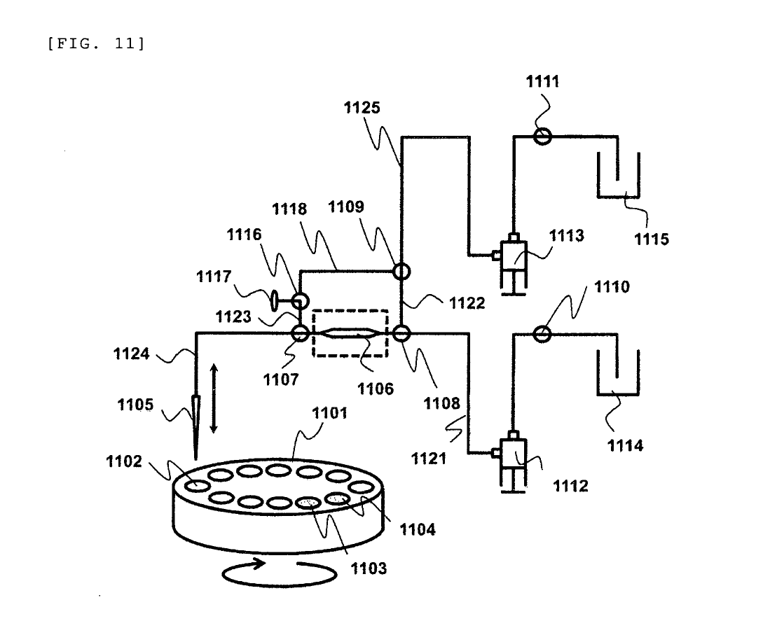

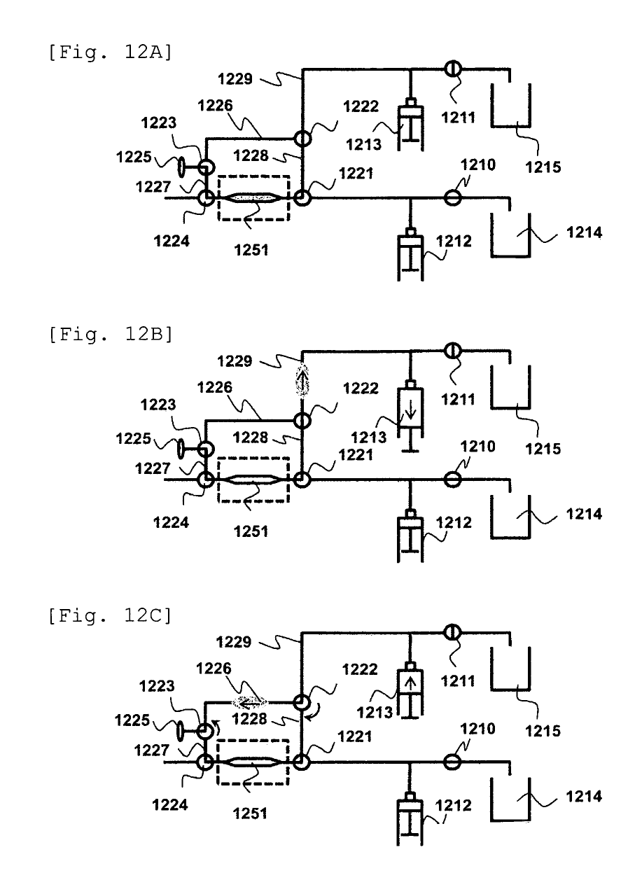

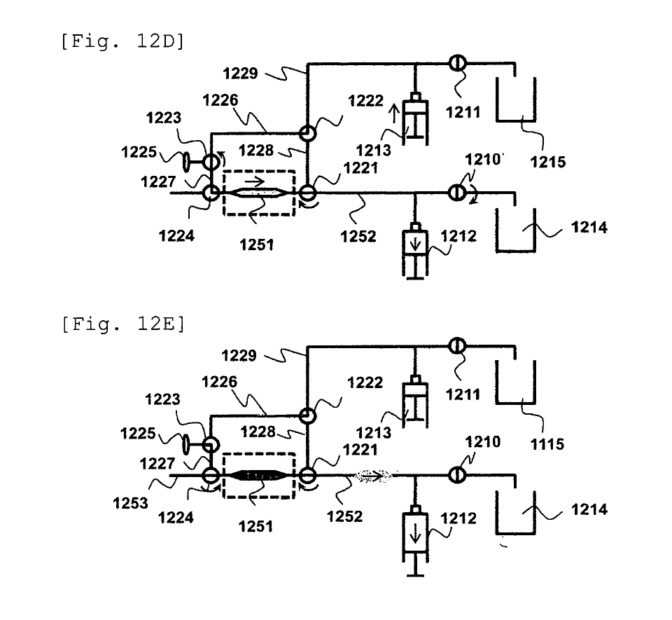

Next, as Tenth Example of the present invention, an apparatus and a method in which the flow passage of the flow cell and the bypass flow passage that can circulate the reagent are formed by disposing switching valves on the upstream and downstream sides in the vicinity of the flow cell, the reagent replacement efficiency is improved by disposing the syringe pump on the downstream side thereof, and the reagent can be reused, will be described with reference to FIGS. 11, 12A, and 12B.

The present example has a configuration similar to the apparatus configuration described in FIG. 9 in Example 8. As illustrated in FIG. 11, the characteristic point of the present example is that the bypass flow passage that can circulate the reagent is formed with respect to the flow passage in a flow cell 1106. The circulation bypass flow passage is configured with flow passages 1122, 1118, and 1123. The circulation bypass flow passage is used for not only selectively discarding but also reusing the reagents in which the reaction has been completed in the flow cell 1106.

Amore specific operation will be described with reference to FIGS. 12A and 12B. The reagent illustrated in gray in FIG. 12A(a) completes the reaction with respect to the micro reaction field in the flow passage in a flow cell 1251. At this time, the concentration of the reaction component contained in the reagent, specifically, four types of fluorescent nucleotides, polymerase which is an enzyme promoting base elongation, or polymerase, primer, nucleotide and the like which are required for the amplification reaction, is retained to be 99% or more of an initial state even after the reaction. Currently, a three-way valve 1221 connects the flow passage in the flow cell 1251 and a flow passage 1228 to each other, and a three-way valve 1222 connects flow passages 1228 and 1229 to each other. In addition, the two-way valve 1211 is in a closed state. Next, in FIG. 12A(b), a syringe pump 1212 is suctioned. Then, due to the generated negative pressure, the reagent moves into the flow passage 1229. Next, in FIG. 12A(c), the three-way valve 1222 is operated and the flow passage 1229 and a flow passage 1226 are connected to each other. Further, by operating a three-way valve 1223, a flow passage 1225 and the flow passage 1226 are connected to each other. The flow passage 1225 is open to the atmosphere, and thus, the air can flow in via the flow passage 1225. In this state, by pushing a syringe pump 1213, a positive pressure is generated and the reagent can be fed to the flow passage 1226. Next, in FIG. 12B(d), the three-way valve 1223 is operated and the flow passage 1226 and a flow passage 1227 are connected to each other. Similarly, the flow passage 1227 and the flow passage in the flow cell 1251 are connected to each other via a three-way valve 1224. Furthermore, by operating the three-way valve 1221, the flow passage in the flow cell 1251 and a flow passage 1252 are connected to each other. In addition, a two-way valve 1210 is closed. In this state, by suctioning the syringe pump 1212, it is possible to feed the reagent to the flow passage in the flow cell 1251 again. As illustrated in (b) and (c), while the reagent is once bypassed to the flow passage 1226, the reaction can proceed smoothly via the normal flow passage. In a case where the reagent which stays in the flow passage 1226 is used again, it is possible to reuse the reagent by following the procedure of FIG. 12B(d). The reuse can in principle be repeated until the substrate concentration decreases below a certain level. By using the method, it is possible to reduce the reagent consumption amount.

In a case where the reagent is finally discarded, as illustrated in FIG. 12B(e), the three-way valve 1224 is operated and a conventional liquid feeding flow passage 1253 and the flow passage in the flow cell 1251 are connected to each other. Furthermore, the syringe pump 1212 is suctioned in a state where the flow passage in the flow cell 1251 and the flow passage 1252 are connected to each other. Accordingly, it is possible to suction the reagent to the flow passage 1252 and to introduce a new reagent similarly indicated in black into the flow passage in the flow cell 1251.

### REFERENCE SIGNS LIST

101, 204, 210, 304, 401, 504, 604, 754, 804, 904, 1004, 1106, 1251, 1304: flow cell

102: micro reaction field

103: heat block

104: Peltier element

105: thermal conduction sheet

106: heat sink

107: XY stage

130: objective lens

112, 1001, 1101, 1301: reagent cartridge

113: fin

116, 202, 302, 502, 602, 702, 802, 902: switching valve

117, 203, 211, 303, 311, 503, 511, 603, 614, 611, 616, 703, 714, 716, 711, 803, 814, 811, 903, 912, 911, 1022, 1014, 1021, 1013, 1124, 1116, 1118, 1125, 1121, 1322, 1307, 1226, 1227, 1228, 1229, 1229, 1252, 1253: flow passage

126, 205, 305, 505, 605, 615, 705, 805, 810, 905, 1005, 1212, 1213: syringe pump

121, 122, 306, 309, 509, 606, 609, 706, 709, 806, 809, 906, 909, 1006, 1009, 1106, 1107, 1109, 1116, 1221, 1222, 1223, 1224: three-way valve

125, 206, 207, 307, 506, 507, 607, 612, 707, 807, 812, 907, 1007, 1110, 1111, 1210, 1211: two-way valve

127, 208, 308, 508, 608, 621, 708, 761, 808, 811, 908, 1008, 1012, 1114, 1115, 1214, 1215, 1308, 1312: waste liquid tank

129, 159: micro photosensor

128, 158: liquid receiving tray

132, 133: LED

134, 135, 137: dichroic mirror

136: emission filter

138, 140: condenser lens

139, 141: CMOS camera

152, 153, 314, 315, 514: bypass flow passage

156, 316, 760, 910, 1011, 1311: vacuum pump

201, 221, 222, 223, 224, 225, 230, 226, 301, 402, 405, 406, 501: reagent

209, 321, 509, 609, 709, 809, 909: shipper tube

210, 310, 521: atmospheric opening tube

151, 313, 510: filter

231, 232, 233, 234, 235, 236, 403, 404: segmental air

222, 223, 224: fluid section

1310: injection port

1. to 15. (canceled)

16. An analysis apparatus comprising:
a flow cell used for analyzing samples;
a sample container for containing a sample;
a reagent container for containing a reagent; and
a pressure generation mechanism for feeding the sample and the reagent to the flow cell through the flow passage,
wherein an atmospheric opening is provided in the flow passage of the flow cell on the upstream side,
wherein a branch portion for branching the flow passage is provided on the downstream side of the flow cell, the pressure generation mechanism is provided on one side of the flow passage branched by the branch portion, and a second pressure generation mechanism is provided on the other side, and
wherein segmental air is sandwiched between the reagents and the reagents are fed.

17. The analysis apparatus according to claim 16,
wherein the pressure generation mechanism is a syringe, and the second pressure generation mechanism is a pump.

18. The analysis apparatus according to claim 16,
wherein both the pressure generation mechanism and the second pressure generation mechanism are syringes.

19. The analysis apparatus according to claim 16,
wherein the pressure generation mechanism is a syringe.

20. The analysis apparatus according to claim 16,
wherein the atmospheric opening is provided in the vicinity of the flow cell.

21. The analysis apparatus according to claim 16,
wherein the branch portion is provided in the vicinity of the flow cell.

22. An analysis apparatus comprising:
a flow cell used for analyzing samples;
a sample container for containing a sample;
a reagent container for containing a reagent;
a pressure generation mechanism for feeding the sample and the reagent to the flow cell through the flow passage;
a merging portion in which a flow passage through which the sample and the reagent flow and another flow passage are merged with each other on the flow passage on the upstream side of the flow cell; and
a second pressure generation mechanism provided on the other flow passage,
wherein segmental air is sandwiched between the reagents and the reagents are fed.

23. The analysis apparatus according to claim 22,
wherein the second pressure generation mechanism is a pump.

24. The analysis apparatus according to claim 22,
wherein the second pressure generation mechanism is a syringe.

25. The analysis apparatus according to claim 22,
wherein a branch portion for branching the flow passage is provided on the downstream side of the flow cell, the pressure generation mechanism is provided on one side of the flow passage branched by the branch portion, and a third pressure generation mechanism is provided on the other side.

26. The analysis apparatus according to claim 25,
wherein the third pressure generation mechanism is a pump.

27. The analysis apparatus according to claim 25,
wherein the third pressure generation mechanism is a syringe.

28. The analysis apparatus according to claim 25,
wherein the branch portion is provided in the vicinity of the flow cell.

29. The analysis apparatus according to claim 22,
wherein the merging portion is provided in the vicinity of the flow cell.
